(19) United States
(12) Patent Application Publication
(10) Pub. No.: US 2010/0187113 A1
(43) Pub. Date: Jul. 29, 2010

(54) CAPILLARY SIEVING ELECTROPHORESIS WITH A CATIONIC SURFACTANT FOR SIZE SEPARATION OF PROTEINS

(76) Inventor: Vladislav Dolnik, Palo Alto, CA (US)

Correspondence Address: Vladislav Dolnik, 1031 Moffett Circle, Palo Alto, CA, 94303-3838, US

(21) Appl. No.: 12/359,345

(22) Filed: Jan. 26, 2009

(51) Int. Cl. B01D 57/02

(52) U.S. Cl. 204/453; 204/451

(57) ABSTRACT

Disclosed herein is a method for size separation of proteins by capillary sieving electrophoresis with cationic surfactant, suitable for molecular-weight determination of proteins in the range between about 14,000 and 500,000, further a composition of a separation medium and of a denaturing solution for said method. In a preferred embodiment, the separation medium comprises a buffer having pH between about 3 and 5.5, a neutral hydrophilic sieving polymer, and between about 0.5 and 30 g/L cationic surfactant.

### REFERENCES CITED

U.S. Patent Documents:
1) U.S. Pat. No. 4,481,094 Stabilized polyacrylamide gels and system for SDS electrophoresis
2) U.S. Pat. No. 5,089,111 Electrophoretic sieving in gel-free media with dissolved polymers
3) U.S. Pat. No. 5,143,753 Suppression of electroosmosis with hydrolytically stable coatings
4) U.S. Pat. No. 5,213,669 Capillary column containing a dynamically cross-linked composition and method of use
5) U.S. Pat. No. 5,275,708 Cetyltrimethylammonium bromide gel electrophoresis
6) U.S. Pat. No. 5,370,777 Capillary column containing removable separation gel composition and method of use
7) U.S. Pat. No. 5,470,916 Formulations for polyacrylamide matrices in electrokinetic and chromatographic methodologies
8) U.S. Pat. No. 5,552,028 Polymers for separation of biomolecules by capillary electrophoresis
9) U.S. Pat. No. 5,567,292 Polymers for separation of biomolecules by capillary electrophoresis
10) U.S. Pat. No. 5,916,426 Polymers for separation of biomolecules by capillary electrophoresis
11) U.S. Pat. No. 6,355,709 Polymers for separation of biomolecules by capillary electrophoresis
12) 13) U.S. Pat. No. 6,646,084 Polymers for separation of biomolecules by capillary electrophoresis
13) U.S. Pat. No. 7,045,048 Polymers for separation of biomolecules by capillary electrophoresis
14) 20050161329 Multiplexed capillary electrophoresis systems
15) 20020049184 Solution of galactomannans as a sieving matrix in capillary electrophoresis

Other References:
1. Shapiro, A. L., Vinuela, E., Maizel, J. V. Molecular weight estimation of polypeptide chains by electrophoresis in SDS-polyacrylamide gels. Biochem. Biophys. Res. Commun. 28 (1967) 815-820.
2. Akins, R. E., Levin, P. M., Tuan, R. S. Cetyltrimethylammonium bromide discontinuous gel electrophoresis: M(r)-based separation of proteins with retention of enzymatic activity. Anal. Biochem. 202 (1992) 172-178.
3. Akins, R. E., Tuan, R. S. Separation of proteins using cetyltrimethylammonium bromide discontinuous gel electrophoresis. Mol. Biotech. 1 (1994) 211-228.
4. Akin, D. T., Shapira, R., Kinkade Jr., J. M. The determination of molecular weights of biologically active proteins by cetyltrimethylammonium bromide-polyacrylamide gel electrophoresis. Anal. Biochem. 145 (1985) 170-176.
5. Eley, M. H., Burns, P. C., Kannapell, C. C., Campbell, P. S. Cetyltrimethylammonium bromide polyacrylamide gel electrophoresis: estimation of protein subunit molecular weights using cationic detergents. Anal. Biochem. 92 (1979) 411-419.
6. Panyim, S., Thitipongpanich, R., Supatimusro, D. A simplified gel electrophoretic system and its validity for molecular weight determinations of protein cetyltrimethylammonium complexes. Anal. Biochem. 81 (1977) 320-327.
7. Schick, M. Influence of a cationic detergent on electrophoresis in polyacrylamide gel. Anal. Biochem. 63 (1975) 345-349.
8. Noolandi J. Theory of DNA gel electrophoresis. Adv. Electroph. 5 (1992) 1-57.
9. Ganzler, K., Greve, K. S., Cohen, A. S., Karger, B. L., Guttman, A., Cooke, N. C. High-Performance Capillary Electrophoresis of SDS Protein Complexes Using UV-Transparent Polymer Networks. Anal. Chem. 64 (1992) 2665-2671.
10. Karim, M. R., Janson, J. C., Takagi, T. Size-dependent separation of proteins in the presence of sodium dodecyl sulfate and dextran in capillary electrophoresis: Effect of molecular weight of dextran. Electrophoresis 15 (1994) 1531-1534.
11. Bae, Y. C., Soane, D. Polymeric Separation Media for Electrophoresis—Cross-Linked Systems or Entangled Solutions. J. Chromatogr. A 652 (1993) 17-22.
12. Dolnik, V., Gurske, W. A., Padua, A. Sieving matrices in capillary electrophoresis: Inflection slope and double reciprocal plot. Electrophoresis 22 (2001) 692-698.
13. Salas-Solano, O., RuizMartinez, M. C., Carrilho, E., Kotler, L., Karger, B. L. A sample purification method for rugged and high performance DNA sequencing by capillary electrophoresis using replaceable polymer solutions. B. Quantitative determination of the role of sample matrix components on sequencing analysis. Anal. Chem. 70 (1998) 1528-1535.
14. Dolnik, V., Gurske, W. A., Padua, A. Galactomannans as a sieving matrix in capillary electrophoresis. Electrophoresis 22 (2001) 707-719.
15. Goetzinger, W., Kotler, L., Carrilho, E., RuizMartinez, M. C., SalasSolano, O., Karger, B. L. Characterization of high molecular mass linear polyacrylamide powder prepared by emulsion polymerization as a replaceable polymer matrix for DNA sequencing by capillary electrophoresis. Electrophoresis 19 (1998) 242-248.
16. Hjerten, S. High-performance electrophoresis: the electrophoretic counterpart of high-performance liquid chromatography. J. Chromatogr. 270 (1983) 1-6.
17. Cohen, A. S., Karger, B. L. High-performance sodium dodecyl sulfate polyacrylamide gel capillary electrophoresis of peptides and proteins. J. Chromatogr. 397 (1987) 409-417.
18. Hjerten, S., Valtcheva, L., Elenbring, K., Eaker, D. High-performance electrophoresis of acidic and basic low-molecular-weight compounds and of proteins in the presence of polymers and neutral surfactants. J. Liq. Chromatogr. 12 (1989) 2471-2499.
19. Sudor, J., Foret, F., Bocek, P. Pressure Refilled Polyacrylamide Columns for the Separation of Oligonucleotides by Capillary Electrophoresis. Electrophoresis 12 (1991) 1056-1058.
20. Heiger, D. N., Cohen, A. S., Karger, B. L. Separation of DNA Restriction Fragments by High-Performance Capillary Electrophoresis with Low and Zero Cross-Linked Polyacrylamide Using Continuous and Pulsed Electric-Fields. J. Chromatogr. 516 (1990) 33-48.
21. Guttman, A., Nolan, J. A., Cooke, N. Capillary Sodium Dodecyl Sulfate Gel Electrophoresis of Proteins. J. Chromatogr. 632 (1993) 171-175.
22. Ganzler, K., Greve, K. S., Cohen, A. S., Karger, B. L., Guttman, A., Cooke, N. C. High-Performance Capillary Electrophoresis of SDS Protein Complexes Using UV-Transparent Polymer Networks. Anal. Chem. 64 (1992) 2665-2671.
23. Izumi, T., Yamaguchi, M., Yoneda, K., Isobe, T., Okuyama, T., Shinoda, T. Use of Glucomannan for the Separation of DNA Fragments by Capillary Electrophoresis. J. Chromatogr. A 652 (1993) 41-46.
24. Kleemiss, M. H., Gilges, M., Schomburg, G. Capillary Electrophoresis of DNA Restriction Fragments with Solutions of Entangled Polymers. Electrophoresis 14 (1993) 515-522.
25. Madabhushi, R. S. Separation of 4-Color DNA-Sequencing Extension Products in Noncovalently Coated Capillaries Using Low-Viscosity Polymer-Solutions. Electrophoresis 19 (1998) 224-230.
26. Lindberg, P., Righetti, P. G., Gelfi, C., Roeraade, J. Electrophoresis of DNA-Sequencing Fragments at Elevated-Temperature in Capillaries Filled with Poly(N-Acryloylaminopropanol) Gels. Electrophoresis 18 (1997) 2909-2914.
27. Chiari, M., Nesi, M., Righetti, P. G. Capillary Zone Electrophoresis of DNA Fragments in a Novel Polymer Network—Poly(N-Acryloylaminoethoxyethanol). Electrophoresis 15 (1994) 616-622.
28. Chiari, M., Riva, S., Gelain, A., Vitale, A., Turati, E. Separations of DNA Fragments by Capillary Electrophoresis in N-Substituted Polyacrylamides. J. Chromatogr. A 781 (1997) 347-355.
29. Motsch, S. R., Kleemiss, M. H., Schomburg, G. Production and Application of Capillaries Filled with Agarose-Gel for Electrophoresis. J. High Resol. Chromatogr. 14 (1991) 629-632.
30. Shapiro, A. L., Maizel, J. V. Molecular weight estimation of polypeptides by SDS-polyacrylamide gel electrophoresis: further data concerning resolving power and general considerations. Anal. Biochem. 29 (1969) 505-514.
31. Weber, K., Osborn, M. The Reliability of Molecular Weight Determinations by Dodecyl Sulfate-Polyacrylamide Gel Electrophoresis. J. Biol. Chem. 242 (1969) 4406-4412.
32. Dunker, A. K., Rueckert, R. R. Observations on molecular weight determinations on polyacrylamide gel. J. Biol. Chem. 244 (1969) 5074-5080.
33. Kresge, N., Simoni, R. D., Hill, R. L. SDS-PAGE to Determine the Molecular Weight of Proteins: the Work of Klaus Weber and Mary Osborn. J. Biol. Chem. 281 (2006) e19-e21.
34. Reynolds, J. A., Tanford, C. Binding of Dodecyl Sulfate to Proteins at High Binding Ratios. Possible Implications for the State of Proteins in Biological Membranes. Proc. Natl. Acad. Sci. U.S.A. 66 (1970) 1002-1007.
35. Williams, J. G., Gratzer, W. B. Limitations of the detergent polyacrylamide gel electrophoresis method for molecular weight determination of proteins. J. Chromatogr. 57 (1971) 121-125.
36. Nelson, C. A. The binding of detergents to proteins. J. Biol. Chem. 246 (1971) 3895-3901.
37. Dolnik, V., Cobb, K. A., Novotny, M.: Preparation of polyacrylamide gel-filled capillaries for capillary electrophoresis. J. Microcol. Sep. 3 (1991) 155-159.
38. Guttman, A., Horvath, J., Cooke, N. Influence of Temperature on the Sieving Effect of Different Polymer Matrices in Capillary SDS Gel Electrophoresis of Proteins. Anal. Chem. 65 (1993) 199-203.
39. Werner, W. E., Demorest, D. M., Stevens, J., Wiktorowicz, J. E. Size-Dependent Separation of Proteins Denatured in SDS by Capillary Electrophoresis Using a Replaceable Sieving Matrix. Anal. Biochem. 212 (1993) 253-258.
40. Guttman, A., Shieh, P., Lindahl, J., Cooke, N. Capillary sodium dodecyl sulfate gel electrophoresis of proteins.2. On the Ferguson method in polyethylene oxide gels. J. Chromatogr. A 676 (1994) 227-231.
41. Tsuji, K. Sodium dodecyl sulfate polyacrylamide gel- and replaceable polymer-filled capillary electrophoresis for molecular mass determination of proteins of pharmaceutical interest. J. Chromatogr. B 662 (1994) 291-299.
42. Guttman, A. On the separation mechanism of capillary sodium dodecyl sulfate-gel electrophoresis of proteins. Electrophoresis 16 (1995) 611-616.
43. Nakatani, M., Shibukawa, A., Nakagawa, T. Effect of temperature and viscosity of sieving medium on electrophoretic behavior of sodium dodecyl sulfate-proteins on capillary electrophoresis in presence of pullulan. Electrophoresis 17 (1996) 1210-1213.
44. Nakatani, M., Shibukawa, A., Nakagawa, T. High-Performance Capillary Electrophoresis of SDS-Proteins Using Pullulan Solution as Separation Matrix. J. Chromatogr. A 672 (1994) 213-218.
45. Hu, S., Ye, Y. L., Surh, G., Clark, J. I., Dovichi, N. J. Analysis of Proteins by Capillary Sds-Dalt Electrophoresis With Laser-Induced Fluorescence Detection. LC GC (Europe) 15 (2002) 166-+.
46. Craig, D. B., Polakowski, P. M., Arriaga, E., Wong, J. C. Y., Ahmadzadeh, H., Stathakis, C., Dovichi, N. J. Sodium dodecyl sulfate-capillary electrophoresis of proteins in a sieving matrix utilizing two-spectral channel laser-induced fluorescence detection. Electrophoresis 19 (1998) 2175-2178.
47. Hunt, G., Nashabeh, W. Capillary electrophoresis sodium dodecyl sulfate nongel sieving analysis of a therapeutic recombinant monoclonal antibody: A biotechnology perspective. Anal. Chem. 71 ( 1999) 2390-2397.
48. Salas-Solano, O., Tomlinson, B., Du., S., Parker, M., Strahan, A., Ma, S. Optimization and validation of a quantitative capillary electrophoresis sodium dodecyl sulfate method for quality control and stability monitoring of monoclonal antibodies. Anal. Chem. 78 (2006) 6583-6594.
49. Yao, S., Anex, D. S., Caldwell, W. B., Arnold, D. W., Smith, K. B., Schultz, P. G. SDS capillary gel electrophoresis of proteins in microfabricated channels. Proc. Natl. Acad. Sci. U. S. A. 96 (1999) 5372-5377.
50. Bousse, L., Mouradian, S., Minalla, A., Yee, H., Williams, K., Dubrow, R. Protein sizing on a microchip. Anal. Chem. 73 (2001) 1207-1212.
51. Werner, W. E., Demorest, D. M., Wiktorowicz, J. E. Automated Ferguson analysis of glycoproteins by capillary electrophoresis using a replaceable sieving matrix. Electrophoresis 14 (1993) 759-763.
52. Guttman, A., Nolan, J. A., Cooke, N. Capillary Sodium Dodecyl Sulfate Gel Electrophoresis of Proteins. J. Chromatogr. 632 (1993) 171-175.
53. Guttman, A. Capillary sodium dodecyl sulfate-gel electrophoresis of proteins. Electrophoresis 17 (1996) 1333-1341.
54. Guttman, A., Nolan, J. Comparison of the Separation of Proteins by Sodium Dodecyl Sulfate-Slab Gel Electrophoresis and Capillary Sodium Dodecyl Sulfate-Gel Electrophoresis. Anal. Biochem., 221 (1994) 285-289.
55. Nozaki, Y., Reynolds, J. A., Tanford, C. The Interaction of a Cationic Detergent with Bovine Serum Albumin and Other Proteins. J. Biol. Chem., 249 (1974) 4452-4459.
56. Reijenga, J. C., Aben, G. V. A., Verheggen, T. H. A. M., Everaerts, F. M. Effect of electroosmosis on detection in isotachophoresis. J. Chromatogr., 260 (1983) 241-254.
57. Tsuda, T. Modification of electroosmotic flow with cetyltrimethylammonium bromide in capillary zone electrophoresis. HRC CC, J. High Res. Chromatogr. Chromatogr. Commun., 10 (1987) 622-624.
58. Corradini, D. Buffer additives other than the surfactant sodium dodecyl sulfate for protein separations by capillary electrophoresis. J. Chromatogr. B, 699 (1997) 221-256.
59. Ding, W. L., Fritz, J. S. Separation of Basic-Proteins and Peptides by Capillary Electrophoresis Using a Cationic Surfactant. J. High Resol. Chromatogr., 20 (1997) 575-580.
60. Chiari, M., Damin, F., Reijenga, J. C. Characterization of poly(dimethylacrylamide) and the combination of poly(vinyl alcohol) and cetyltrimethylanlmonium bromide as dynamic electroosmotic flow suppression agents in capillary electrophoresis. J. Chromatogr. A, 817 (1998) 15-23.
61. Ong, C. P., Ng, C. L., Lee, H. K., Li, S. F. Y. The Use of Mixed Surfactants in Micellar Electrokinetic Chromatography. Electrophoresis, 15 (1994) 1273-1275.
62. Gilbert, H. F. Thiol/disulfide exchange equilibria and disulfide bond stability. Meth. Enzymol., 251 (1995) 8-28.
63. Menger, F. M., Keiper, J. S. Gemini surfactants. Angew. Chem., 39 (2000) 1906-1920.

### FIELD OF THE INVENTION

The present invention relates to size separation of proteins by capillary electrophoresis in sieving media, wherein one or more cationic surfactants form charged complexes with the proteins and equalize their surface charge density, making their migration in sieving media independent of their intrinsic charge and thus allowing their size separation and molecular-weight determination. Specifically, the invention is directed to capillary sieving electrophoresis of proteins in the presence of cationic surfactants at low pH.

### BACKGROUND OF THE INVENTION

Electrophoresis in Sieving Media

Electrophoretic sieving media are used to size separate biopolymers: nucleic acids, polysaccharides, and proteins. They provide a system of obstacles in the electrophoretic migration path so that migrating biopolymers collide with the obstacles and these collisions retard their apparent migration velocity. Larger molecules and particles are retarded in their migration more than small molecules. The first electrophoretic sieving media were starch and polyacrylamide gel. Nucleic acids are equally ionized at non-acidic pH and need not be modified to size separate during electrophoretic migration in sieving media. On the other hand, protein ionization and charge significantly vary depending on the amino acid composition. Therefore, native proteins are not size separated in sieving media in absence of ionic surfactants. However, when heated with an ionic surfactant, proteins denature and bind the surfactants, generating complexes with more or less equal surface charge density. These complexes migrate in sieving media according to their size. Ionic surfactants such as sodium dodecyl sulfate (SDS) (Shapiro, A. L. et al., 1967), cetyltrimethylammonium bromide (CTAB) Panyim, S. et al., 1977), cetylpyridinium chloride (Schick, M., 1975) have been used to equalize the surface charge density of proteins prior electrophoresis.

Slab Gel Electrophoresis

SDS electrophoresis in polyacrylamide slab gel (SDS PAGE) was the first method separating proteins according to their size (Shapiro, A. L. et al., 1967;Shapiro, A. L., Maizel, J. V., 1969; Weber, K., Osborn, M., 1969; Dunker, A. K., Rueckert, R. R., 1969). Formation of SDS-protein complexes is independent of ionic strength (Reynolds, J. A., Tanford, C., 1970). However, some proteins exhibit an anomalous migration in SDS PAGE (Shapiro, A. L. et al., 1967; Williams, J. G., Gratzer, W. B., 1971). The anomalous migration of acidic proteins in SDS PAGE was, however, normalized by esterification of carboxyl groups (Williams, J. G., Gratzer, W. B., 1971) suggesting insufficient surfactant binding. This hypothesis was corroborated by an observation that some acidic proteins, such as pepsin, papain, and glucose oxidase do not bind measurable amount of SDS (Nelson, C. A., 1971).

Shortly after the invention of SDS PAGE, a method separating proteins by polyacrylamide gel electrophoresis (PAGE) in the presence of cationic surfactants was described (Williams, J. G., Gratzer, W. B., 1971). A study based on observations of behavior of protein-cationic-surfactant-complexes followed, predicting a failure of the electrophoresis in the presence of cationic surfactants to determine molecular weights of proteins (Nozaki, Y. et al., 1974). Later, cetylpyridinium chloride (Schick, M., 1975) and cetyltrimethylammonium bromide (Akins, R. E. et al., 1992; Akins, R. E., Tuan, R. S., 1994; Akin, D. T. et al., 1985; Eley, M. H. et al., 1979; Panyim, S. et al., 1977) were used for size separations of proteins by PAGE. Several protocols have been developed to denature proteins with cetyltrimethylammonium bromide (Akins, R. E. et al., 1992; Akins, R. E., Tuan, R. S., 1994; Akin, D. T. et al., 1985; Eley, M. H. et al., 1979; Panyim, S. et al., 1977), including a protocol without any heating of the sample (Akins, R. E. et al., 1992). Capillary Electrophoresis

When electrophoresis of proteins in sieving media was transferred from slab gels into capillaries, crosslinked polyacrylamide gel was initially used as the sieving matrix (Hjerten, S., 1983; Cohen, A. S., Karger, B. L., 1987; Dolnik, V. et al., 1991). When linear hydrophilic polymers were introduced as a replaceable sieving matrix for separation of polynucleotides (Hjerten, S. et al., 1989), various polymers were utilized as a sieving matrix for electrophoretic size separation of biopolymers, including linear polyacrylamide (Ganzler, K. et al., 1992; Sudor, J. et al., 1991; Heiger, D. N. et al., 1990, Werner, W. E. et al., 1993;;Karim, M. R. et al., 1994;Tsuji, K., 1994; Hu, S. et al., 2002; Craig, D. B. et al., 1998; Hunt, G., Nashabeh, W., 1999; Salas-Solano, O. et al., 2006)), poly(ethylene oxide) (Guttman, A. et al., 1993), dextran (Ganzler, K. et al., 1992), guaran (Dolnik, V. et al., 2001), glucomannan (Izumi, T. et al., 1993), poly(vinyl alcohol) (Kleemiss, M. H. et al., 1993), poly(dimethyl acrylamide) (Madabhushi, R. S., 1998), poly(hydroxypropyl acrylamide) (Lindberg, P. et al., 1997), poly(ethoxyethyl acrylamide) (Chiari, M. et al., 1994; Chiari, M. et al., 1997), agarose (Motsch, S. R. et al., 1991), and pullulan (Nakatani, M. et al., 1996; Nakatani, M. et al., 1994). Capillary size separations of proteins were performed exclusively by SDS capillary sieving electrophoresis (CSE) and limited to a molecular-weight range between about 14,000 and 205,000. The method was also modified for size separation of proteins on microchip (Yao, S. et al., 1999; Bousse, L. et al., 2001) with poly(dimethyl acrylamide) as a sieving polymer (Bousse, L. et al., 2001). Capillary electrophoresis brought a number of advantages as compared to electrophoresis in slab gel: faster analysis, automation, higher separation efficiency, higher detection sensitivity. Nevertheless, a small size of capillaries emphasized the effect of the capillary wall: typically used fused silica capillaries contained ionized silanol groups on their internal surface, resulting in strong wall adsorption, significant electroosmotic flow, eddy migration, and consequent mediocre separation efficiency. Electroosmotic flow was eventually suppressed by applying a hydrolytically stable neutral coating on the capillary wall (U.S. Pat. No. 5,143,753). Nevertheless, in SDS CSE, SDS adsorbs on the neutral coating and generates secondary electroosmotic flow. Mediocre reproducibility and separation efficiency are the results of this deleterious effect. Currently, SDS CSE is performed in bare capillaries after extensive rinsing of the capillary between runs, significantly reducing the throughput of the analysis. Hypothetically, electroosmotic flow in SDS CSE could be also suppressed by reducing pH of the sieving medium and a consequent suppression of the silanol ionization in the capillary wall. However, SDS binding of proteins is weaker at pH<6 and SDS electrophoresis at this pH results in significantly broader peaks (Gilbert, H. F., 1995) excluding this alternative from a real world practice.

### Polymer Solutions as a Sieving Matrix

When migration of biopolymers in sieving media was studied in a greater detail, three distinct migration modes were identified, depending on the pore size of the sieving matrix and size of the polyelectrolyte: Ogston mode, reptation without stretching, and reptation with stretching (Noolandi J., 1992). In capillary electrophoresis, where sieving polymers serve as the sieving matrix, the pore size of the sieving matrix is fine tuned by changing the concentration of the sieving polymer (Ganzler, K. et al., 1992; Karim, M. R. et al., 1994). Molecular weight of the sieving polymer also plays an important role, particularly in separation of large polyelectrolytes migrating in the reptation-with-stretching mode (Bae, Y. C., Soane, D., 1993). High-molecular-weight polymers are typically better sieving matrices than those with low molecular weight (Dolnik, V. et al., 2001) although blends of polymers of high and low molecular weight were also advocated and used (Salas-Solano, O. et al., 1998). Stiffness and branching of the sieving polymers affects the sieving properties of the sieving matrix as well: branched polysaccharides such as dextran or Ficoll® exhibit rather limited sieving and are suitable more for separation of polyelectrolytes migrating in the Ogston mode. Stiff polysaccharides such as hydroxyethyl cellulose, guaran, and locust bean gum (Dolnik, V. et al., 2001) form a rigid sieving matrix at lower molecular weights and/or concentrations than easily bending synthetic polymers such as linear polyacrylamide. In practical CSE analysis, viscosity is a limiting factor as high pressure (about 900 psi) is necessary to replace a viscous sieving matrix in the capillary. The viscosity of the sieving matrix makes a practical limit when increasing the concentration and molecular weight of the sieving polymer. In DNA sequencing by capillary electrophoresis, the weight molecular weight (M_{w}, further molecular weight) of linear polyacrylamide serving as a sieving polymer, exceeded 10,000,000 (Goetzinger, W. et al., 1998). In CSE of proteins, most proteins were separated in sieving media with large pore size and sieving polymers typically did not exceed molecular weight of 1 million. To provide efficient sieving, the sieving polymers should have molecular weight about 100,000 and more. However, this value is rather arbitrary, as lower-molecular-weight polymers can be prepared at a higher concentration and still keep the viscosity of the solution at an acceptable level. Stiff polysaccharides, such as hydroxyethyl cellulose, guaran, or locust bean gum can be used even at a lower molecular-weight. On the other hand, crosslinked and branched polysaccharides, such as dextran, are preferably used at high molecular weight (2 million and higher).

Cationic Surfactant in Capillary Electrophoresis

Cetyltrimethylammonium bromide was used in capillary electrophoresis for two purposes: a) as a dynamic coating to reverse the direction of electroosmotic flow (Reijenga, J. C. et al., 1983; Tsuda, T., 1987; Corradini, D., 1997; Ding, W. L., Fritz, J. S., 1997; Chiari, M. et al., 1998), b) as a pseudostationary phase in capillary electrokinetic micellar chromatography (Ong, C. P. et al., 1994). None cationic surfactant has been used for size separation of proteins by capillary sieving electrophoresis. An interesting group of potential cationic surfactants are gemini surfactants (Menger, F. M., Keiper, J. S., 2000) with two amino groups connected by an aliphatic arm but they have not been used in capillary electrophoresis yet.

### SUMMARY OF THE INVENTION

The present invention is suitable for a fast, quantitative, and highly reproducible size separation of proteins by means of capillary sieving electrophoresis. Disclosed herein are a composition of a separation medium and a protein denaturing solution, and a method of capillary sieving electrophoresis in the presence of a cationic surfactant for size separation of proteins with molecular weight in the range between about 14,000 and about 500,000. In the preferred embodiment, the separation medium comprises an acidic buffer that keeps pH in the range between about 3 and about 5, a hydrophilic sieving polymer with moderate viscosity, and between about 0.5 and about 30 g/L cationic surfactant.

### BRIEF DESCRIPTION OF THE DRAWINGS

FIG. 1 shows separation of model protein mixture. Separation medium: 100 mM β-alanine, 100 mM glutamic acid, 1 g/L cetyldimethylethylammonium bromide (CDMEAB), 16 g/L poly(ethylene oxide) (M_{w} 400,000). Coated capillary CZECH Cap™ (Alcor BioSeparations, Palo Alto, Calif. U.S.A.): total length=335 mm, effective length=250 mm, ID=75 μm, OD=360 μm. Voltage: +10 kV. Detection: UV absorption at 214 nm. Electrokinetic injection: 6 s at +8 kV. Sample: about 1 g/L proteins in 10 g/L CDMEAB, 100 mM KCl, 10 g/L dithiotreitol (DTT) heated 5 min at 95° C. (lysozyme), 2 min at 95° C. (all other proteins).

FIG. 2 is the plot of protein mobility vs. their logarithmic molecular weight calculated from the electropherogram in FIG. 1.

FIG. 3 displays the separation of BSA oligomers. Injection: 15 s at +8 kV. Sample: 10 g/L BSA in 1 g/L cetyldimethylethylammonium bromide (CDMEAB). All other experimental conditions were same as in FIG. 1.

FIG. 4 presents the plot of the mobility vs. logarithmic molecular weight for BSA oligomers as calculated from the electropherogram in FIG. 3.

FIG. 5 shows 10 overlaid electropherograms of model proteins from 10 consecutive runs. Separation medium: 100 mM γ-aminobutyric acid, 100 mM glutamic acid, 25 g/L CTAB, 20 g/L poly(ethylene oxide) (M_{w} 200,000). Capillary: bare capillary, l(total)=335 mm, l(effective)=250 mm, ID=75 μm, OD=360 μm. Voltage: +10 kV. Electrokinetic injection: 3 s at +3 kV. Sample: about 0.8 g/L each protein in 30 mM CTAB, 60 mM DTT, 5 min incubated at 95° C. (lysozyme), 2 min at 95° C. (all other proteins).

FIG. 6 depicts calibration curves of model proteins with electrokinetic injection 30 s at +10 kV. Sample denaturing solution: 10 g/L CDMEAB, 10 g/L DTT, 100 mM KCl, 5 min incubated at 95° C. (lysozyme), 2 min at 95° C. (all other proteins). Separation medium: 100 mM β-alanine, 100 mM glutamic acid, 1 g/L CDMEAB, 20 g/L poly(ethylene oxide) (M_{w} 200,000). Capillary CZECH Cap™ (Alcor BioSeparations, Palo Alto, Calif. U.S.A.): total length=335 mm, effective length=250 mm, ID=75 μm, OD=360 μm. Voltage: +10 kV. ♦—lysozyme, ×—BSA (monomer), ▪—β-lactoglobulin, Δ—ovalbumin.

### DETAILED DESCRIPTION OF THE INVENTION

Cationic surfactants

The cationic surfactant used in the sieving matrix should exhibit a sufficient solubility in water and, simultaneously strongly bind proteins. Primary, secondary, tertiary or quaternary amines with one or more long aliphatic chains are suitable surfactant cations for CSE of proteins. Typically longer aliphatic chains are preferred because then the surfactant binds proteins more strongly. Solubility of the cationic surfactant in water may be a limiting factor for a practical use. Cationic surfactants suitable for capillary sieving electrophoresis of proteins contain one or more of the following cations: octadecyldimethylethylammonium, cetyldimethylethylammonium, tetradecyldimethylethylammonium, dodecyldimethylethylammonium, octadecyltrimethylammonium, cetyltrimethylammonium, tetradecyltrimethylammonium, dodecyltrimethylammonium, octadecylpyridinium, tetradecylpyridinium, dodecylpyridinium, octadecylammonium, cetylammonium, tetradecylammonium, dodecylammonium, decylammonium, didodecyldimethylammonium, and a cationic gemini surfactant alkanediyl-.α.,.ω.-bis(dimethylalkylammonium), with a formula CₘH₂ₘ₊₁(CH₃)₂N⁺(CH₂)ₛN⁺(CH₃)₂CₘH_{2m +1}, m being 12, 14, 16, or 18 and s being 2, 3, 4, 5, 6, 7, or 8.

The counter anion in the cationic surfactant can be an inorganic anion such as chloride, bromide, sulfate, bicarbonate, etc. The nature of the counter anion plays a significant role. In capillary sieving electrophoresis of monoclonal antibodies, a broad system peak appears when cetyltrimethylammonium bromide is used as the cationic surfactant. With cetyltrimethylammonium chloride, the system peak is much smaller and such a sieving medium is more preferred.

Acidic Buffer

Size separations of proteins in capillary format based on SDS suffer from mediocre separation efficiency and lower reproducibility of qualitative and quantitative analysis. Capillary sieving electrophoresis of proteins with cationic surfactant at low pH, where ionization of silanol groups in the capillary wall is suppressed, is a solution to this problem. The separation medium contains a cationic surfactant, a sieving polymer, and an acidic buffer with pH below 5. Low pH is absolutely essential for high performance separations, because silanol groups in the fused-silica capillary wall are not ionized at low pH. This leads to a lower electroosmotic flow, which otherwise deteriorates electrophoretic separation. At low pH, the adsorption of cationic surfactants on the capillary wall, which normally leads to a significant reversed electroosmotic flow, is also suppressed.

The pH of the sieving matrix, however, requires some optimization: Below pH 3, the high-mobility H⁺ ion contributes significantly to the conductivity of the sieving matrix. This results in elevated Joule heat and overheating of the capillary. Above pH 5.5, the silanol ionization is not negligible and electroosmotic flow becomes a serious issue. Keeping the pH of the sieving matrix at about pH 4 is the best compromise. One possibility is to use a free weak acid, e.g., acetic acid, as the only electrolyte. Another option is to use fully ionized cation, e.g., Tris, with a buffering anion, e. g., formate, acetate, propionate, butyrate, capronate, valproate, pimelate, fumarate, maleate, succinate, glutarate, adipate, malate, tartrate, glycolate, lactate, 2-hydroxybutyrate, 2-hydroxyisobutyrate, citrate, nicotinate, glutamate, and aspartate. pH can be also kept at a proper level with a buffering cation, e.g., β-alanine, γ-aminobutyric acid (GABA), glycine, ε-aminocaproic acid, or nicotinamide and a fully ionize anion. Probably the most attractive buffering option is an equimolar mixture of a weak base and a weak acid, having close pK's, e.g., GABA (pK 4.0) and glutamic acid (pK 4.2), β-alanine (pK 3.6) and glutamic acid (pK 4.2), and β-alanine (pK 3.6) and 2-hydroxy-isobutyric acid (pK 3.9). It is essential to use dicarboxylic and tricarboxylic acids at pH, where only one carboxylic group is partly dissociated. Other factors than pK, which may be difficult to predict from the physicochemical properties of the buffers, may be also important: Buffers containing β-alanine show better separation efficiency than buffers with GABA, but exhibit some protein adsorption on the wall. This results in a minor but discernable baseline elevation when proteins migrate through the detection cell.

Sieving Polymer

The sieving matrix enables size separation of proteins. It provides obstacles in the migration path and makes proteins complexed with cationic surfactants to electrophoreticaly migrate according to their size. The sieving polymer should be (i) soluble in water, (ii) non-ionic, (iii) not significantly binding cationic surfactants, (iv) sufficient sieving (i.e., having sufficient molecular weight), (v) non UV absorbing, if UV detection is used. The sieving properties of the matrix can be fine tuned by changing the molecular weight and concentration of the sieving polymer. Higher concentration and/or higher molecular weight of the sieving polymer results in smaller pores, i.e., in more efficient sieving but also in longer migration times. Simultaneously, the viscosity rises and may prevent fast replacement of the sieving matrix in the capillary. Linear polysaccharides, such as hydroxyethyl cellulose, hydroxypropyl cellulose, scleroglucan, guaran, locust bean gum, glucomannan, and pullulan, have a stiff molecule and will be typically used at concentrations from about 4 to about 60 g/L and molecular weight from about 20,000 to about 500,000. Hydrophilic synthetic polymers, such as linear polyacrylamide, poly(dimethyl acrylamide), poly(hydroxyethyl acrylamide), poly(hydroxypropyl acrylamide), poly(ethoxyethyl acrylamide), poly(vinyl alcohol), poly(vinyl pyrrolidone), and poly(ethylene oxide) will be effective sieving polymers at concentration from about 8 to about 80 g/L and molecular weight from about 100,000 to about 1 million. Branched polysaccharides such as dextran or Ficoll® are less efficient sieving polymers and have to be used at concentration from about 100 to about 400 g/L and molecular weight about 2 million. UV absorbing polymers, such as poly(vinyl pyrrolidone) will not properly work in CSE with UV detection but may be used in CSE with laser induced fluorescence detection.

We disclose here a separation medium for capillary electrophoretic size separation of proteins, comprising
a) a cationic surfactant at concentration from about 5 to about 20 g/L containing one or more of the following cations: octadecyldimethylethylammonium, cetyldimethylethylammonium, tetradecyldimethylethylammonium, dodecyldimethylethylammonium, octadecyltrimethylammonium, cetyltrimethylammonium, tetradecyltrimethylammonium, dodecyltrimethylammonium, octadecylpyridinium, tetradecylpyridinium, dodecylpyridinium, octadecylammonium, cetylammonium, tetradecylammonium, dodecylammonium, decylammonium, didodecyldimethylammonium, and cationic gemini surfactant alkanediyl-.α.,.ω.-bis(dimethylalkylammonium), with a formula CₘH₂ₘ₊₁(CH₃)₂N⁺(CH₂)ₛN⁺(CH₃)₂CₘH₂ₘ₊₁, wherein m is 12, 14, 16, or 18, and is 2, 3, 4, 5, 6, 7, or 8;
b) a buffer having pK from about 3 to about 5.5, at concentration from about 20 mM to about 200 mM, selected from the group consisting of: glycine, β-alanine, γ-aminobutyric acid, δ-aminovaleric acid, ε-aminocaproic acid, nicotinamide, formate, acetate, propionate, butyrate, capronate, valproate, pimelate, fumarate, maleate, succinate, glutarate, adipate, malate, tartrate, glycolate, lactate, 2-hydroxybutyrate, 2-hydroxyisobutyrate, citrate, nicotinate, glutamate, and aspartate.
c) a sieving polymer being
   a linear polysaccharide at concentration from about 4 g/L to about 60 g/L, selected from the group consisting of hydroxyethyl cellulose, hydroxypropyl cellulose, scleroglucan, guaran, locust bean gum, glucomannan and pullulan; or
      a synthetic hydrophilic linear polymer at concentration from about 8 g/L to about 80 g/L, selected from the group consisting of polyacrylamide, poly(dimethyl acrylamide), poly(hydroxyethyl acrylamide), poly(hydroxypropyl acrylamide), poly(ethoxyethyl acrylamide), poly(vinyl alcohol), poly(vinyl pyrrolidone), and poly(ethylene oxide), or a branched polysaccharide at concentration from about 100 g/L to about 600 g/L, selected from the group consisting of dextran and Ficoll®.

### Sample Denaturing Solution

The sample denaturing solution should contain a cationic surfactant, which may but need not be identical with the cationic surfactant in the sieving matrix, a reduction agent, which can disrupt disulfide bridges (β-mercaptoethanol or dithiotreitol), and a high-mobility cation that allows a transient isotachophoresis during the electrokinetic injection and helps to focus the analytes into sharp bands.

The other role of the high-mobility cation in the sample denaturing solution is to allow the quantitative analysis with electrokinetic injection. Pressure injection, common in capillary electrophoresis, is not recommended for quantitative analysis by capillary sieving electrophoresis. The sieving matrix contains a polymer solution and exhibits an increased viscosity. As the result, the precision of the pressure injection may be compromised. If EOF in the separation capillary is suppressed, the amount of analytes injected electrokinetically is not necessarily proportional to their concentration in the sample and a non-linear calibration curve may be obtained. This holds particularly for low-conductivity samples. Nevertheless, if an electrolyte is added and the analytes do not contribute significantly to the overall conductivity of the sample, the calibration curves become linear. Moreover, polymer solution on the capillary inlet tip may affect the reproducibility of quantitative analysis; a tip wash can lead to a better reproducibility.

We disclose here a protein denaturing solution for the sample preparation prior capillary sieving electrophoresis with cationic surfactant comprising:
a) from about 2 g/L to about 200 g/L cationic surfactant containing one or more of the following cations:

octadecyldimethylethylammonium, cetyldimethylethylammonium, tetradecyldimethylethylammonium, dodecyldimethylethylammonium, octadecyltrimethylammonium, cetyltrimethylammonium, tetradecyltrimethylammonium, dodecyltrimethylammonium, octadecylpyridinium, tetradecylpyridinium, dodecylpyridinium, octadecylammonium, cetylammonium, tetradecylammonium, dodecylammonium, decylammonium, didodecyldimethylammonium, and cationic gemini surfactant alkanediyl-.α.,.ω.-bis(dimethylalkylammonium), with a formula CₘH₂ₘ₊₁(CH₃)₂N⁺(CH₂)ₛN⁺(CH₃)₂CₘH₂ₘ₊₁, wherein m is 12, 14, 16, or 18, and s is 2, 3, 4, 5, 6, 7, or 8;
b) reducing agent being from about 4 to about 20 g/L dithiotreitol;
c) a high-conductivity electrolyte being from about 20 mM to about 100 mM salt, selected from the group consisting of potassium chloride, potassium phosphate, ammonium chloride, and ammonium phosphate.
   As low pH suppresses electroosmotic flow, capillary sieving electrophoresis with cationic surfactant can be comfortably performed in bare capillaries. However, coated capillaries suppressing residual electroosmotic flow are necessary for high performance separations with unparalleled separation efficiency and run-to run reproducibility.

Method of Capillary Sieving Electrophoresis with a Cationic Surfactant

Here we disclose a method for capillary sieving electrophoresis with cationic surfactant for size separation of proteins comprising steps:
a) Rinsing the separation capillary with about 0.1 M citric acid at the pressure of about 1 bar for about 7 minutes;
b) Filling the capillary with a separation medium for capillary electrophoretic size separation of proteins, at the pressure of about 1 bar for about 3 min, said separation medium consisting essentially of a cationic surfactant; an acidic buffer; and a sieving polymer, wherein said sieving polymer is selected from the group consisting of linear polyacrylamide, poly(dimethyl acrylamide), poly(hydroxyethyl acrylamide), poly(hydroxypropyl acrylamide), poly(ethoxyethyl acrylamide), poly(vinyl alcohol), poly(vinyl pyrrolidone), hydroxyethyl cellulose, scleroglucan, guaran, locust bean gum, glucomannan, pullulan, dextran, and poly(ethylene oxide), said poly(ethylene oxide) with a proviso that when said sieving polymer is poly(ethylene oxide), it is in the concentration from about 16 g/L to about 60 g/L;
c) Sample injection, wherein first the capillary inlet is washed by a triple immersion in distilled water, then the capillary inlet and cathode are immersed in the sample, capillary outlet and anode are immersed in a vial containing separation medium, and finally an injection voltage from about 0.5 kV to about 12 kV is applied between the anode and cathode for about 1 s to about 60 s;
d) Separation, wherein the capillary inlet and cathode are immersed in a vial containing said separation medium, capillary outlet and anode are immersed in other vial containing said separation medium, then a separation voltage being applied on the anode and cathode at from about 1 kV to about 20 kV for the duration from about 1 min to about 20 min;
e) Detection, wherein absorption of monochromatic light having wavelength from about 210 nm to about 220 nm is measured and plotted in electropherogram for further data analysis.

### EXAMPLES

The separations described in these examples were performed in 3D CE capillary electrophoresis instrument at 20° C. in a bare or coated capillary of internal diameter 75 μm and outer diameter 360 μm with UV detection at 214 nm.

### Example 1

Preparation and Composition of the Sieving Matrix

The separation medium for capillary sieving electrophoresis with a cationic surfactant was formulated to contain cetyldimethylethylammonium bromide (CDMEAB), or cetyltrimethylammonium bromide (CTAB), or cetyltrimethylammonium chloride (CTAC) as the cationic surfactant, polyacrylamide or poly(ethylene oxide) (PEO) as a sieving matrix, β-alanine or γ-aminobutyric acid as the buffering co-ion, and 2-hydroxyisobutyric acid or glutamic acid as the buffering counter-ion. Standard formulations contained CDMEAB; however, the formulations with CTAC were preferred for separation of monoclonal antibodies. Formulation with β-alanine were designed for high resolution separations, formulations with γ-aminobutyric acid were preferred where straight baseline was necessary. The specific formulations contained:
a) 2 g/L CTAC, 100 mM γ-aminobutyric acid, 100 mM glutamic acid, pH about 4.2, and 15 g/L polyacrylamide (M_{w} 600,000-1,000,000);
b) 2 g/L CTAC, 100 mM γ-aminobutyric acid, 100 mM glutamic acid, pH about 4.2, and 10 g/L polyacrylamide (M_{w} 600,000-1,000,000);
c) 1 g/L CDMEAB, 100 mM β-alanine, 100 mM glutamic acid, pH about 3.9, and 20 g/L PEO (M_{w} 200,000);
d) 2 g/L CDMEAB, 100 mM γ-aminobutyric acid, 100 mM glutamic acid, pH about 4.2, and 20 g/L PEO (M_{w} 200,000);
e) 2 g/L CDMEAB, 100 mM β-alanine, 100 mM 2-hydroxyisobutyric acid, pH about 3.7, and 20 g/L PEO (M_{w} 200,000);
f) 25 mM CTAB, 100 mM γ-aminobutyric acid, 100 mM glutamic acid, pH about 4.2, and 20 g/L PEO (M_{w} 200,000)
g) 2 g/L CTAC, 100 mM β-alanine, 100 mM glutamic acid, pH about 3.9, and 15 g/L polyacrylamide (M_{w} 600,000-1,000,000);

### Example 2

Composition of Sample Denaturing Solution and Method of Sample Preparation

Several compositions of the sample denaturing solution were formulated to enable protein quantitation with electrokinetic injection:
a) 10 g/L CDMEAB, 100 mM KCl, and 10 g/L dithiotreitol (DTT);
b) 10 g/L CDMEAB, 100 mM potassium phosphate, and 10 g/L DTT;
c) 10 g/L CTAC, 100 mM potassium phosphate, and 10 g/L DTT;
d) 30 mM CTAB, 100 mM KCl, and 60 mM DTT;
e) 30 mM CTAB, and 60 mM DTT.

During the sample preparation, proteins were dissolved in the sample denaturing solution and incubated at 95° C. for 2 min. Some proteins, e.g., lysozyme, were resistant to the thermal denaturation with cationic surfactants and an extended incubation at 95° C. was necessary (5 min in case of lysozyme). Proteins such as BSA, on the other hand, did not require any denaturation at all prior to electrophoresis.

### Example 3

The Method of Capillary Sieving Electrophoresis

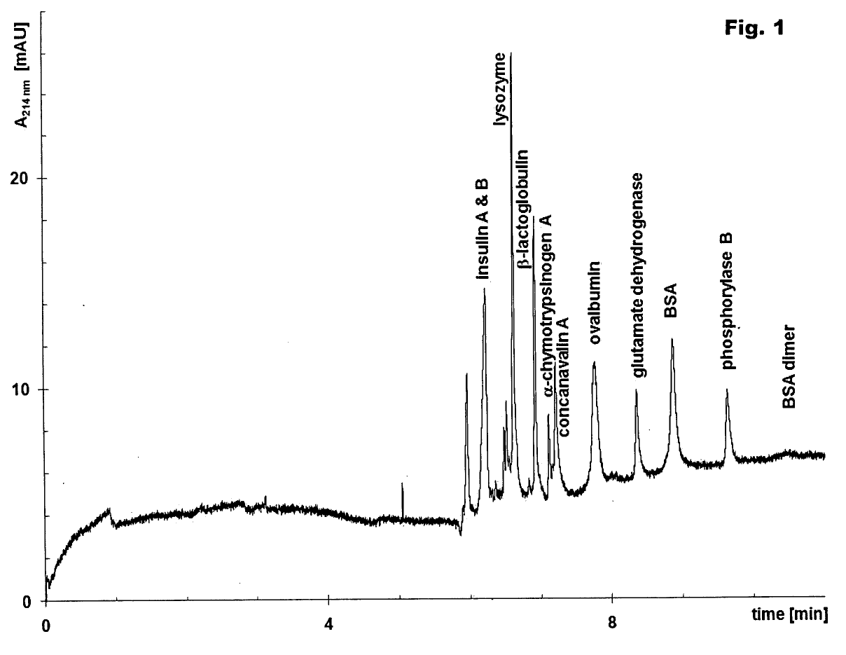

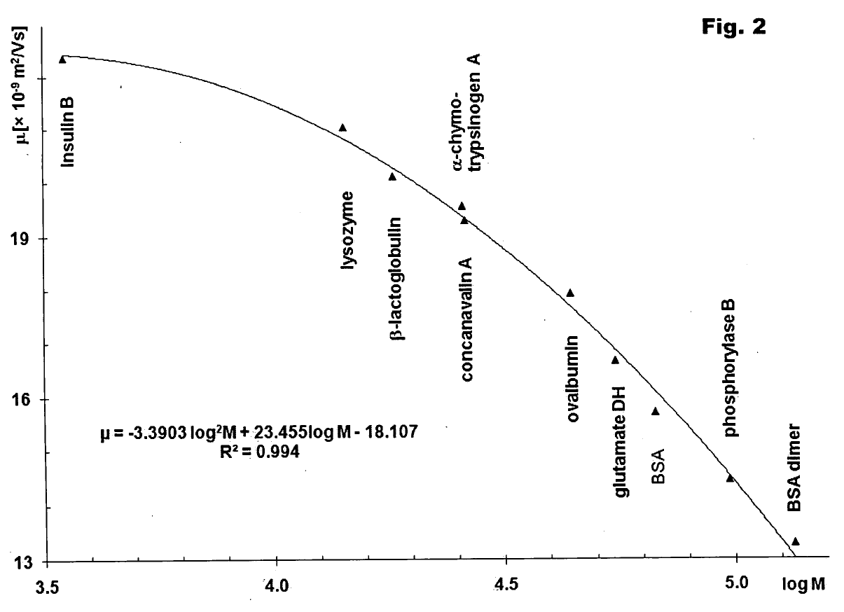

Capillary sieving electrophoresis with a cationic surfactant was performed in a fused silica capillary, 75 μm ID, 360 μm OD, 335 mm total length, 250 mm effective length. Bare capillaries were also used, but for high-resolution separations, capillaries with internal hydrophilic coating were preferred. After each electrophoretic run, the capillary was flushed with 100 mM citric acid at pressure of 930 mbar for 7 min to remove the sieving matrix from the previous run and wash proteins and other material potentially adsorbed on the capillary wall. In the next step, the capillary was prepared for the next run: the fresh sieving matrix was pumped into the capillary with pressure of 930 mbar for 3 min. The samples were injected either electrokinetically or by pressure. The amount of the injected sample depended on the protein concentration in the sample. The samples prepared with the sample denaturing solution containing 10 g/L CDMEAB, 100 mM KCl, and 10 g/L dithiotreitol and containing 0.1-1 g/L proteins were typically injected for 8 s at 6 kV. The separation was performed at +10 and typically took 10-12 minutes. The separation of a model protein mixture is shown in FIG. 1. The electrophoretic mobility of the proteins was plotted against the logarithmic molecular weight to provide calibration curve for determination of protein molecular weight (FIG. 2). A quadratic equation was preferred to mathematically express the relationship between electrophoretic mobility and logarithmic molecular weight.

### Example 4

The Method of Capillary Sieving Electrophoresis with Cationic Surfactant for Separation of Large Proteins

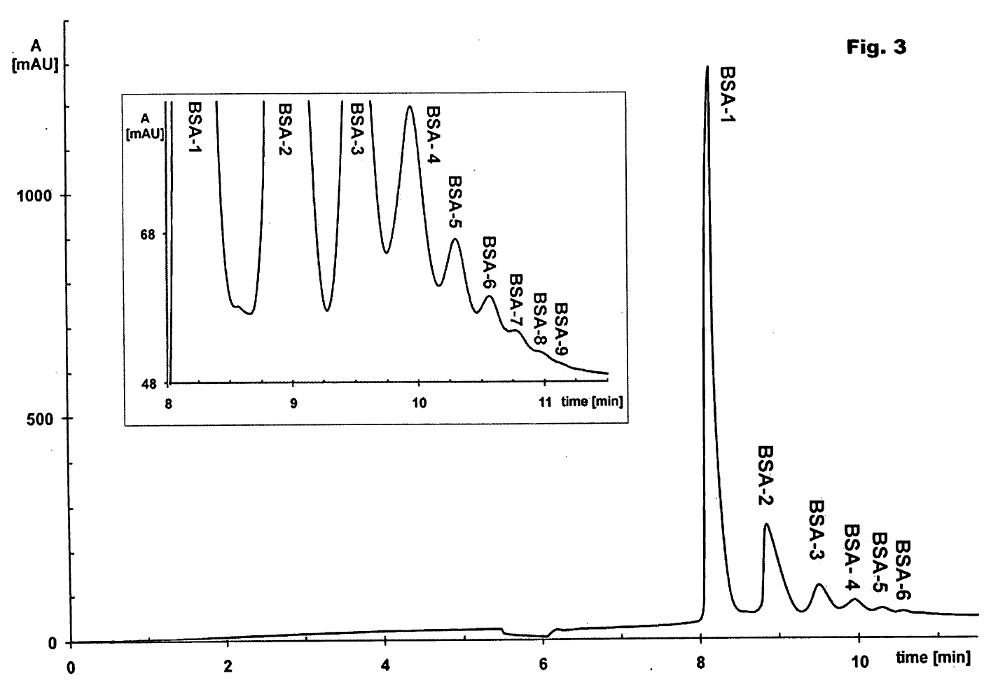

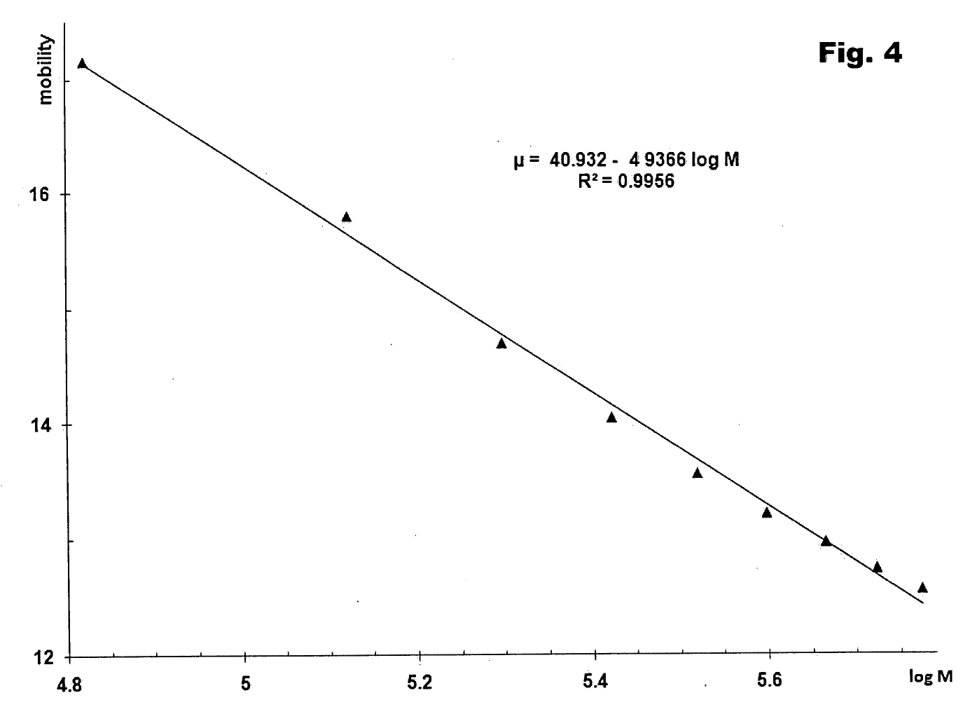

For the separation of native BSA oligomers, the sample containing 10 g/L BSA in 1 g/L CDMEAB was injected at 8 kV for 15 s. The capillary sieving electrophoresis (CSE) of BSA oligomers took about 12 min. and revealed eight to nine peaks (FIG. 3). While the BSA monomer was overloaded, the BSA oligomers from dimer to at least octamer were separated. With the BSA molecular weight of 66,000, it meant proteins separated at least in the range between about 14,000 (lysozyme) and about 536,000 (BSA octamer). The electrophoretic mobilities of the BSA oligomers were plotted against the corresponding logarithmic molecular weights (FIG. 4). The obtained straight-line suggested BSA oligomers to be used for calibration of molecular-weight in the range about 60,000 and about 500,000.

### Example 5

Separation Efficiency

CSE with a cationic surfactant provided narrow peaks with high separation efficiency. Table 1 summarizes the average separation efficiency of model proteins from 7 runs. The calculation of the separation efficiency from a half-height peak width that assumed ideal Gaussian peaks provided results rather lower than the calculation based on an unrevealed algorithm used in ChemStation software (Agilent).

TABLE 1
Average separation efficiency of protein peaks (n = 7)

| | Average | | | Average | Average | | | Average |
|---|---|---|---|---|---|---|---|---|
| | separation | | | separation | separation | | | separation |
| | efficiency^{a} | | | efficiency^{a} | efficiency^{b} | | | efficiency^{b} |
| | [plates] | SD^{a} | RSD^{a} | [plates/m] | [plates] | SD^{b} | RSD^{b} | [plates/m] |
| insulin B | 52,000 | 3,600 | 7.1% | 208,000 | | | | |
| lysozyme | 445,000 | 46,900 | 10.5% | 1,780,000 | 615,000 | 15,500 | 2.5% | 2,430,000 |
| β-lactoglobulin | 383,000 | 30,400 | 7.9% | 1,532,000 | 526,000 | 18,300 | 3.5% | 2,104,000 |
| α-chymotrypsinogen A | 204,000 | 15,300 | 7.5% | 816,000 | | | | |
| concanavalin A | 111,000 | 22,000 | 19.9% | 444,000 | | | | |
| ovalbumin | 46,000 | 2,700 | 5.9% | 184,000 | | | | |
| glutamate DH | 148,000 | 17,900 | 12.1% | 592,000 | | | | |
| BSA monomer | 54,000 | 12,000 | 22.3% | 216,000 | | | | |
| phosphorylase b | 134,000 | 14,300 | 10.7% | 536,000 | | | | |

^{a}calculated from half-height peak width
^{b}obtained directly from the ChemStation software (Agilent)
SD—standard deviation
RSD—relative standard deviation

### Example 6

Reproducibility of Migration Times

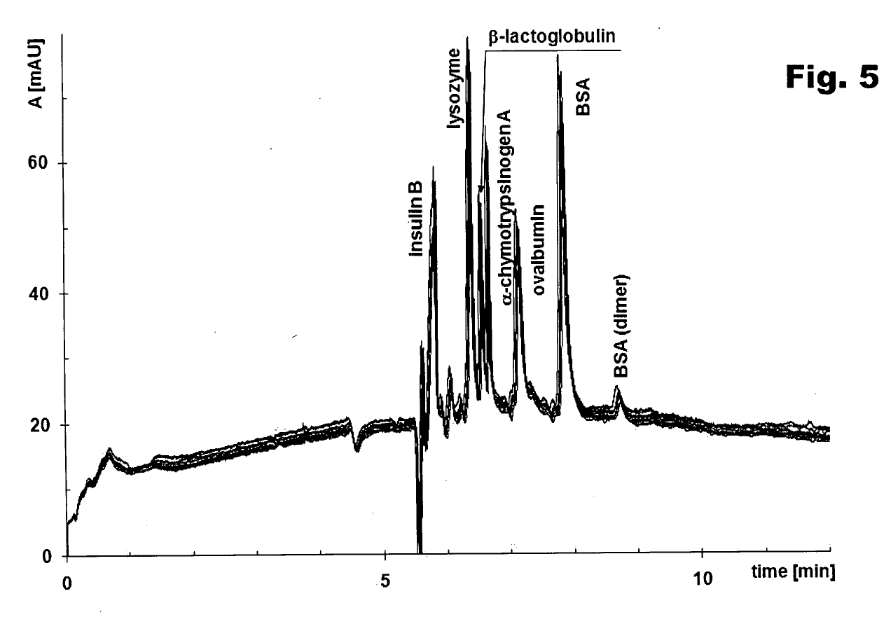

Low pH of the separation medium minimized electroosmotic flow and improved reproducibility of the electrophoretic separation of proteins. 10 overlaid consecutive electropherograms of a model mixture containing 0.8 g/L of insulin B, lysozyme, β-lactoglobulin, α-chymotrypsinogen A, ovalbumin, and BSA are shown in FIG. 5. Run-to-run reproducibility of the migration times ranged from 0.14% to 0.25% and is summarized in Table 2.

TABLE 2
Run-to-run reproducibility of migration times (n = 10).

| | Average tₘ | SD | RSD |
|---|---|---|---|
| Protein | [min] | [min] | [%] |
| Insulin B | 6.09 | 0.009 | 0.14 |
| Lysozyme | 6.68 | 0.010 | 0.15 |
| β-lactoglobulin | 6.88 | 0.010 | 0.15 |
| α-chymotrypsinogen A | 7.04 | 0.011 | 0.16 |
| Ovalbumin | 7.56 | 0.014 | 0.19 |
| BSA | 8.27 | 0.021 | 0.25 |

### Example 7

Quantitative Analysis

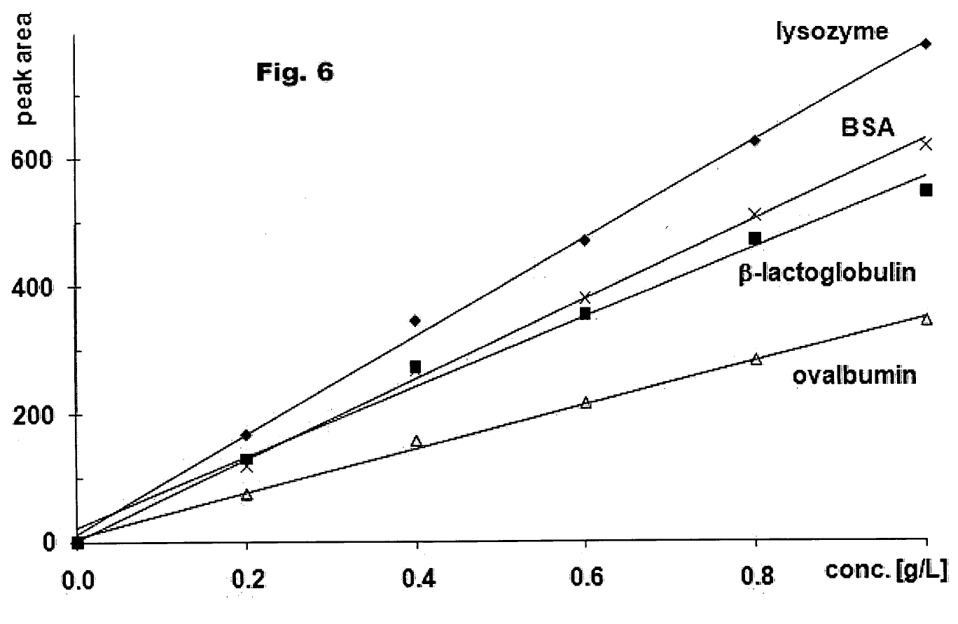

CSE with cationic surfactant allowed quantitative analysis with electrokinetic injection. When proteins were denatured in 10 g/L CDMEAB, 100 mM KCl, and 10 g/L DTT and injected 30 s at +10 kV, the calibration lines for lysozyme, β-lactoglobulin, ovalbumin, and BSA were linear in the concentration range 0-1.0 g/L (FIG. 6). The squared correlation coefficient ranged from 0.99 for β-lactoglobulin to 0.998 for BSA, In terms of the peak area reproducibility, the relative standard deviation ranged from 1.1% (lysozyme) to 2.1% (BSA) at 0.2 g/L (n=10).

TABLE 3
Reproducibility of the peak area for 0.2 g/L proteins
injected 30 s at +10 kV (n = 10).

| | Average | SD | RSD |
|---|---|---|---|
| lysozyme | 168.3 | 1.8 | 1.1% |
| β-lactoglobulin | 133.6 | 1.4 | 1.1% |
| ovalbumin | 76.5 | 1.0 | 1.4% |
| BSA | 121.9 | 2.6 | 2.1% |

What is claimed:

1. A separation medium for capillary electrophoretic size separation of proteins, consisting essentially of:
a cationic surfactant;
an acidic buffer having pH in the range from about 3 to about 5.5; and
a sieving polymer, wherein said sieving polymer is selected from the group consisting of linear polyacrylamide, poly(dimethyl acrylamide), poly(hydroxyethyl acrylamide), poly(hydroxypropyl acrylamide), poly(ethoxyethyl acrylamide), poly(vinyl alcohol), poly(vinyl pyrrolidone), hydroxyethyl cellulose, scleroglucan, guaran, locust bean gum, glucomannan, pullulan, dextran, and poly(ethylene oxide), said poly(ethylene oxide), with a proviso that when said sieving polymer is poly(ethylene oxide) it is in the concentration from about 16 g/L to about 60 g/L.

2. The separation medium for capillary electrophoretic size separation of proteins of claim 1, wherein said cationic surfactant comprises at least one surfactant cation selected from the group consisting of:
octadecyldimethylethylammonium, cetyldimethylethylammonium, tetradecyldimethylethylammonium, dodecyldimethylethylammonium, octadecyltrimethylammonium, cetyltrimethylammonium, tetradecyltrimethylammonium, dodecyltrimethylammonium, octadecylpyridinium, tetradecylpyridinium, dodecylpyridinium, octadecylammonium, cetylammonium, tetradecylammonium, dodecylammonium, decylammonium, didodecyldimethylammonium, and a cationic gemini surfactant alkanediyl-.α.,.ω.-bis(dimethylalkylammonium), with a formula CₘH₂ₘ₊₁(CH₃)₂N⁺(CH₂)ₛN⁺(CH₃)₂CₘH₂ₘ₊₁, wherein m is 12, 14, 16, or 18, and s is 2, 3, 4, 5, 6, 7, or 8.

3. The separation medium for capillary electrophoretic size separation of proteins of claim 1, wherein said cationic surfactant is cetyldimethylethylammonium bromide in the concentration range from about 0.5 g/L to about 30 g/L.

4. The separation medium for capillary electrophoretic size separation of proteins of claim 1, wherein said cationic surfactant is cetyltrimethylammonium chloride in the concentration range from about 0.5 g/L to about 30 g/L.

5. The separation medium for capillary electrophoretic size separation of proteins of claim 1, wherein said cationic surfactant is cetyltrimethylammonium bromide in the concentration range from about 0.5 g/L to about 30 g/L.

6. The separation medium for capillary electrophoretic size separation of proteins of claim 1, wherein said acidic buffer comprises at least one of the following buffering substances selected from the group consisting of:
glycine, β-alanine, γ-aminobutyric acid, δ-aminovaleric acid ε-aminocaproic acid, nicotinamide, formate, acetate, propionate, butyrate, capronate, valproate, pimelate, fumarate, maleate, succinate, glutarate, adipate, malate, tartrate, glycolate, lactate, 2-hydroxybutyrate, 2-hydroxyisobutyrate, citrate, nicotinate, glutamate, and aspartate.

7. The separation medium for capillary electrophoretic size separation of proteins of claim 6, wherein said acidic buffer comprises from about 20 mM to about 200 mM β-alanine, and from about 20 mM to about 200 mM glutamic acid.

8. The separation medium for capillary electrophoretic size separation of proteins of claim 6, wherein said acidic buffer comprises from about 20 mM to about 200 mM γ-aminobutyric acid, and from about 20 mM to about 200 mM glutamic acid.

9. The separation medium for capillary electrophoretic size separation of proteins of claim 6, wherein said acidic buffer comprises from about 20 mM to about 200 mM β-alanine and from about 20 mM to about 200 mM 2-hydroxyisobutyric acid.

10. The separation medium for capillary electrophoretic size separation of proteins according to claim 7, consisting essentially of:
from about 16 g/L to about 24 g/L poly(ethylene oxide), having molecular weight from about 200,000 to about 600,000;
from about 20 mM to about 200 mM β-alanine;
from about 20 mM to about 200 mM glutamic acid; and
from about 0.5 g/L to about 30 g/L cetyldimethylethylammonium bromide.

11. The separation medium for capillary electrophoretic size separation of proteins according to claim 8, consisting essentially of:
from about 8 g/L to about 30 g/L polyacrylamide, having molecular weight from about 100,000 to about 1,000,000;
from about 20 mM to about 200 mM γ-aminobutyric acid;
from about 20 mM to about 200 mM glutamic acid; and
from about 0.5 g/L to about 30 g/L cetyltrimethylammonium chloride.

12. The separation medium for capillary electrophoretic size separation of proteins according to claim 9, consisting essentially of:
from about 16 g to about 24 g/L poly(ethylene oxide), having molecular weight from about 200,000 to about 600,000;
from about 20 mM to about 200 mM β-alanine;
from about 20 mM to about 200 mM 2-hydroxyisobutyric acid; and
from about 0.5 g/L to about 30 g/L cetyldimethylethylammonium bromide.

13. A separation medium for capillary electrophoretic size separation of proteins, consisting essentially of 20 g/L poly(ethylene oxide), having molecular weight about 200,000, 100 mM β-alanine, 100 mM glutamic acid, and 1 g/L cetyldimethylethylammonium bromide, and having pH about 3.9.

14. A separation medium for capillary electrophoretic size separation of proteins, consisting essentially of 15 g/L polyacrylamide having molecular weight 600,000-1 million, 100 mM 13-alanine, 100 mM glutamic acid, and 1 g/L cetyltrimethylammonium chloride, and having pH about 3.9.

15. A separation medium for capillary electrophoretic size separation of proteins, consisting essentially of 10 g/L polyacrylamide having average molecular weight 600,000-1 million, 100 mM γ-aminobutyric acid, 100 mM glutamic acid, and 2 g/L cetyltrimethylammonium chloride, and having pH about 4.2.

16. A protein denaturing solution for sample preparation of proteins prior capillary electrophoretic size separation, comprising at least one surfactant cation selected from the group consisting of
octadecyldimethylethylammonium, cetyldimethylethylammonium, tetradecyldimethylethylammonium, dodecyldimethylethylammonium, octadecyltrimethylammonium, tetradecyltrimethylammonium, dodecyltrimethylammonium, octadecylpyridinium, tetradecylpyridinium, dodecylpyridinium, octadecylammonium, cetylammonium, tetradecylammonium, dodecylammonium, decylammonium, didodecyldimethylammonium, and a cationic gemini surfactant alkanediyl-.α.,.ω.-bis(dimethylalkylammonium), with a formula CₘH₂ₘ₊₁(CH₃)₂N⁺(CH₂)ₛN⁺(CH₃)₂CₘH₂ₘ₊₁, wherein m is 12, 14, 16, or 18, and s is 2, 3, 4, 5, 6, 7, or 8.

17. The protein denaturing solution for sample preparation of proteins prior capillary electrophoretic size separation of claim 16, wherein said protein denaturing solution comprises 10 g/L cetyldimethylethylammonium bromide, 100 mM potassium phosphate, and 10 g/L dithiotreitol.

18. The protein denaturing solution for sample preparation of proteins prior capillary electrophoretic size separation of claim 16, wherein said protein denaturing solution comprises 10 g/L cetyldimethylethylammonium bromide, 100 mM potassium chloride, and 10 g/L dithiotreitol.

19. The protein denaturing solution for sample preparation of proteins prior capillary electrophoretic size separation of claim 16, wherein said protein denaturing solution comprises 10 g/L cetyltrimethylammonium chloride, 100 mM potassium phosphate, and 10 g/L dithiotreitol.

20. A method for capillary sieving electrophoresis with cationic surfactant for size separation of proteins, comprising steps:
a) Rinsing the separation capillary with about 0.1 M citric acid at the pressure of about 1 bar for about 7 minutes;
b) Filling the capillary with a separation medium for capillary electrophoretic size separation of proteins, at the pressure of about 1 bar for about 3 min, said separation medium consisting essentially of:
a cationic surfactant;
an acidic buffer; and
a sieving polymer, wherein said sieving polymer is selected from the group consisting of linear polyacrylamide, poly(dimethyl acrylamide), poly(hydroxyethyl acrylamide), poly(hydroxypropyl acrylamide), poly(ethoxyethyl acrylamide), poly(vinyl alcohol), poly(vinyl pyrrolidone), hydroxyethyl cellulose, scleroglucan, guaran, locust bean gum, glucomannan, pullulan, dextran, and poly(ethylene oxide), said poly(ethylene oxide), with a proviso that when said sieving polymer is poly(ethylene oxide), it is in the concentration from about 16 g/L to about 60 g/L;
c) Sample injection, wherein the capillary inlet is washed by a triple immersion in distilled water, then the capillary inlet and cathode are immersed in the sample, capillary outlet and anode are immersed in a vial containing separation medium, and finally an injection voltage from about 0.5 kV to about 12 kV is applied between the anode and cathode for about 1 s to about 60 s;
d) Separation, wherein the capillary inlet and cathode are immersed in a vial containing said separation medium, capillary outlet and anode are immersed in other vial containing said separation medium, then a separation voltage from about 1 kV to about 20 kV being applied between the anode and cathode for about 1 minute to about 20 minutes;
e) Detection, wherein absorption of monochromatic light having wavelength from about 210 nm to about 220 nm is measured and plotted in electropherogram for further data analysis.
